(19) United States
(12) Patent Application Publication
(10) Pub. No.: US 2010/0225955 A1
(43) Pub. Date: Sep. 9, 2010

(54) Print Button Widget

(76) Inventors: Kevin D. Almen, Albany, OR (US); Michael Bennion, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/396,670

(22) Filed: Mar. 3, 2009

(51) Int. Cl. G06F 3/12

(52) U.S. Cl. 358/1.15

(57) ABSTRACT

An embodiment of the invention relates to a method including determining when a print button widget on a webpage has been accessed by a user from a communication device accessing the webpage, recording an identity of an online publisher hosting or maintaining the webpage, issuing a print instruction to the communication device for the communication device to create a print job when the print button widget has been accessed by the user, identifying at least one detail of the print job, sending a notification and the at least one detail of the print job to an exchange server, and sharing an online publisher report including the at least one detail of the print job with at least one advertiser

### BACKGROUND

Identifying and collecting information from an internet print job executed from webpage conventionally involves an advertiser or third party surveying one or more existing individuals about internet print jobs the individual has executed. This often involves the advertiser or third party questioning the individual about previous or present printings the individual has or is currently executing. As a result, time may be wasted and resources may be lost due the advertiser or third party often manually filtering the survey information collected for inconsistent information and in consideration of inaccurate memories or testimonies by the individuals.

### BRIEF DESCRIPTION OF THE DRAWINGS

Various features and advantages of the invention will be apparent from the detailed description which follows, taken in conjunction with the accompanying drawings, which together illustrate, by way of example, features of the invention and wherein:

FIG. 1 illustrates a system storing a print button widget accessible by a communication device through a webpage, where the webpage may receive the print button widget from a server, an exchange server, an Ad server, or an advertiser according to an embodiment of the invention.

FIG. 2 illustrates a print button widget being accessed by a communication device and an exchange server acquiring at least one detail of a print job to create an online publisher fee and report for at least one advertiser according to an embodiment of the invention.

FIG. 3 illustrates an exchange server acquiring at least one detail of a print job to create or update a print usage entry for a corresponding online publisher on a database and the exchange server calculating an online publisher fee to share with an advertiser based on the print usage entry and an online publisher report according to an embodiment of the invention.

FIG. 4 illustrates a print button widget that may be embedded into a system and/or may be stored on a removable medium being accessed by a communication device according to an embodiment of the invention.

FIG. 5 is a flow chart illustrating a method for sharing an online publisher report of at least one detail of a print job with at least one advertiser when a print button widget on a webpage has been accessed according to an embodiment of the invention.

FIG. 6 is a flow chart illustrating a method for calculating an online publisher fee based on an online publisher report of at least one detail of a print job and sharing the online publisher fee and at least one detail of the print job with at least one advertiser according to an embodiment of the invention.

### DETAILED DESCRIPTION

The present invention differs from previous approaches by utilizing a print button widget to collect at least one detail of a print job. A common practice for conventional data collection of internet print jobs is for an advertiser or third party to manually contact one or more individuals to collect data concerning previous or current print jobs the individuals have executed from the webpage. As a result, the advertiser or third party may find that time may be wasted and incorrect information may be collected in consideration of inaccurate memories and testimonies. The present invention alleviates much of these concerns by automatically polling at least one detail of the print job from a communication device whenever a print job is initiated by a user accessing the print button widget from a webpage.

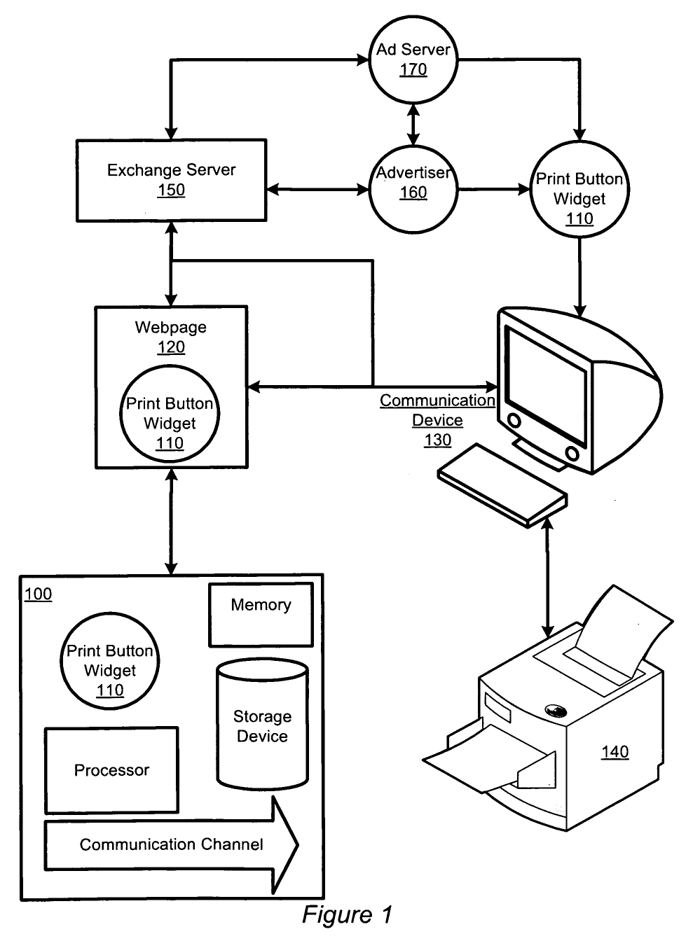

FIG. 1 illustrates a system storing a print button widget accessible by a communication device from a webpage, where the webpage may receive the print button widget through a server, an exchange server, an Ad server, or an advertiser according to an embodiment of the invention. The system may be a computer, server, and/or an online publisher. Additionally, the print button widget may be stored and accessed through an exchange server, an Ad server, an advertiser, and/or any other device or entity that may store the print button widget for access. Further, as illustrated in FIG. 1, the system may include a processor, memory, storage, and a communication channel for coupled devices of the system to communicate with one another. The system may include additional devices and/or components and may be attached and/or coupled to additional devices or components in addition to and/or in lieu of those depicted in FIG. 1.

As noted above, a system 100 may store a print button widget 110. The print button widget 110 may be a software application stored and accessed through a storage medium readable and accessible by the system 100, an exchange server 150, at least one Ad server 170, at least one advertiser 160, and/or a communication device 130. The print button widget 110 may also be stored on a computer readable medium readable and accessible by the system 100, the exchange server 150, at least one Ad server 170, at least one advertiser 160 and/or the communication device 130 from a different location. Further, the print button widget 110 may be stored and/or accessed through a server connected through a local area network or a wide area network. In one embodiment, the print button widget 110 may be a plug-in or java script code for a webpage and/or a web browser that may be executed when a user accesses a webpage 120 from the communication device 130.

Additionally, as noted above, the print button widget 110 may be requested by a communication device 130 when a user from the communication device 130 requests to access the webpage 120, including the print button widget 110. For the purposes of this application, a webpage 120 may be understood to be a blog site, chat site, social network site, gaming site, e-commerce site, news or information site, and/or any web based document that may include at least one content that may be viewable by a user through a communication device 130.

Further, as noted above, the system 100 which hosts the webpage 120 may be an online publisher. An online publisher may be an entity that owns, creates, and/or maintains the webpage 120 where the print button widget 110 may be accessed from. The online publisher may utilize a local server, web server, and/or any additional server to store to host the webpage 120 and/or the print button widget 110. Additionally, as noted above, the webpage 120 hosted on the online publisher and the print button widget 110 may be accessible by a user from the communication device 130.

The print button widget 110 may receive input and/or send instructions to one or more communication devices 130 accessing the print button widget 110. The communication device 130 may be a computer, desktop, laptop, server, internet tablet, PDA, cell phone, and/or any device that may access at least one content on the webpage 120 hosted by the online publisher. The communication device 130 may access the webpage 120 and/or at least one content physically or wirelessly through a local area network and/or through a wide area network. Additionally, the user may utilize a web browser application installed on the communication device 130 to access the print button widget 110 on the webpage 120.

In one embodiment, when a user initially accesses the webpage 120 using the communication device 130. The webpage 120 may issue an instruction for the communication device 130 to request to download the print button widget 110 through the online publisher, at least one advertiser 160, at least one Ad server 170, and/or the exchange server 150. At least one Ad server 170 may have access to at least one advertisement and/or plug-in from at least one advertiser 160 to upload the communication device 130. Further, at least one Ad server may be a server that may be coupled to the exchange server 150, the online publisher, and/or the communication device 130. In one embodiment, when a request is made, the print button widget 110 may be retrieved from at least one Ad server 170 through the exchange server 150. The print button widget 110 may then be loaded onto the webpage 120 for display on the communication device 134.

Once the print button widget 110 has been downloaded for display on the webpage 120, the communication device 130, the web browser application, and/or the print button widget 110 may scan for a request to access the print button widget 110 by the user. In one embodiment, the user may access the print button widget 110 on the webpage 120 by “clicking” on the print button widget 110 on the webpage 120 using an input device on the communication device 130 when the user wishes to print at least one content the user is currently viewing on the webpage 120. If the print button widget 110 has been accessed, the print button widget 110 may record an identity of the online publisher hosting or maintaining the site. In one embodiment, the online publisher may send an identification signal to the exchange server when the print button widget 110 has been accessed in order to identify itself. In another embodiment, the print button widget 110 may create a meta data associated with the online publisher and include the identity of the online publisher in the meta data.

The print button widget 110 may additionally issue a print instruction to the communication device 130 for the communication device 130 to create a print job when the print button widget 110 has been accessed. In one embodiment, the communication device 130 may be coupled to a printing apparatus 140 either locally or remotely. The printing apparatus 140 may be a device that may print at least one content from the webpage 120 after the user access the print button widget 110. At least one content may consist of images, text, symbols, characters, and/or a combination of the above. The printing apparatus 140 may be a local or remote printing apparatus. Additionally, the printing apparatus 140 may be coupled to the communication device 130 physically or wireless through a local or wide area network. In one embodiment, the printing apparatus 140 may be a local or a server printing apparatus that is physically coupled to the communication device 130. In another embodiment, the printing apparatus 140 may be a kiosk and/or a remote printing apparatus 140 that that the user may access from a remote location.

Further, the print button widget 110 may poll the communication device 130 with a tracking tool to identify and collect at least one detail of the print job. In one embodiment, the tracking tool may be an internet cookie that the online publisher may utilize to identify details and/or information associated with the communication device 130. In another embodiment, the tracking tool may be a print log application that may be coupled to the communication device 130. At least one detail of the print job may include, but is not limited to, an identity of the online publisher, a manufacture name of a printing apparatus that communication device 130 prints to, a number of pages included in the print job, at least one content included in the print job, and a genre of at least one content included in the print job. The print button widget 110 may further send a notification to the exchange server 150 when at least one content from the webpage 120 has been printed. Further, the print button widget 110 may send details of at least one content printed to the exchange server 150 and an instruction for the exchange server 150 to create an online publisher report and calculate an online publisher fee for the online publisher.

An exchange server 150 may be a server that is coupled to the online publisher, at least one Ad server 170, at least on advertiser 160, and/or the communication device 130. The exchange server 150 may poll at least one ad server 170, at least one advertiser 160, and the online publisher for the print button widget 110 and/or at least one ad that may be transferred for display on the webpage 120. Additionally, the exchange server 150 may receive information and/or at least one detail of a print job from the communication device 130 when the print button widget 110 on the webpage 120 has been accessed. The exchange server 150 may further utilize at least one detail of the print job to create or update an online publisher report for at least one advertiser 160 and/or a print usage entry for the online publisher on a database. Further, the exchange server 150 or at least one advertiser may create or update at least one ad shared with the online publisher for display on the web page 120 in response to at least one content and the genre of at least one content printed. In one embodiment, this may occur immediately when the print button widget 110 has been accessed with the webpage 120 refreshing or reloading to include at least one created or updated ad. In another embodiment, at least one created or updated ad may be displayed on the webpage 120 the next time the user accesses the webpage 120.

The online publisher report may include the identity of the online publisher, the manufacturer name of the printing apparatus the communication device 130 prints to, a number of pages included in the print job, at least one content included in the print job, and/or a genre of the at least one content included in the print job. The online publisher report may include additional information in addition to and/or in lieu those noted above. Further, in one embodiment, creating the online publisher report may include creating and/or updating a print usage entry for the corresponding online publisher. Similar to the online publisher report, the print usage entry may include the identity of the online publisher, at least one manufacturer name of at least one printing apparatus the user prints to, a total number of pages printed from the online publisher, at least one content printed from the online publisher, and a genre of at least one content printed. The print usage entry may be stored on a database on the exchange server 150. The database may further include additional pint usage entries for additional online publishers.

Further, the exchange server 150 may analyze each page printed and determine an amount of ink used in printing each page. In one embodiment, this may include identifying each content printed on each page and identifying the manufacturing name and model of the printing apparatus 140. Calculations may then be made to determine an amount of ink that may be required to print each content based on the printing apparatus manufacturing name and model.

The exchange server 150 may additionally determine and calculate an online publisher fee owed to the corresponding online publisher using the online publisher report and the print usage entry. In one embodiment, in calculating the online publisher fee owed, the exchange server 150 may only include prints that were printed using a specific manufacturer printing apparatus. Further, the exchange server 150 may consider the number of pages printed using the specific manufacturer printing apparatus and assign a previously defined page cost to be paid for each page printed. Additionally, the exchange server 150 may consider the total amount of ink used, by determining the amount of ink used in printing each page and combining them. The exchange server 150 may also consider at least one content included in the print job and the genre of each content. The exchange server 150 may consider additional factors in addition to and/or in lieu of the factors noted above when calculating an online publisher fee.

After the online publisher report has been created and the online publisher fee has been calculated, the print button widget 110 may issue an instruction for the exchange server 150 to share both the online publisher report and online publisher fee with at least one advertiser 160. At least one advertiser 160 may be a company or an entity that may be interested in at least one detail of the print job. The exchange server 150 may share the online publisher report and the online publisher fee after a predefined period of time, after the online publisher fee has reached a predefined value, after the print job has been completed, or after the number of times the print button widget 110 has been accessed exceeds a predefined click number. After at least one advertiser 160 has receive the online publisher report, at least one detail of the print job, and the online publisher fee, at least one advertiser 160 may issue a payment of the online publisher fee to the online publisher hosting the webpage 120. Additionally, at least one advertiser 160 may issue an instruction to the exchange server 150 to reset at least one detail of the online publisher after issuing the payment. In one embodiment, this may include resetting the online publisher fee, the amount of pages printed, and/or the amount of ink used. Further, at least one advertiser 160 may share a genre of at least one content, included from the online publisher report, with an additional advertiser.

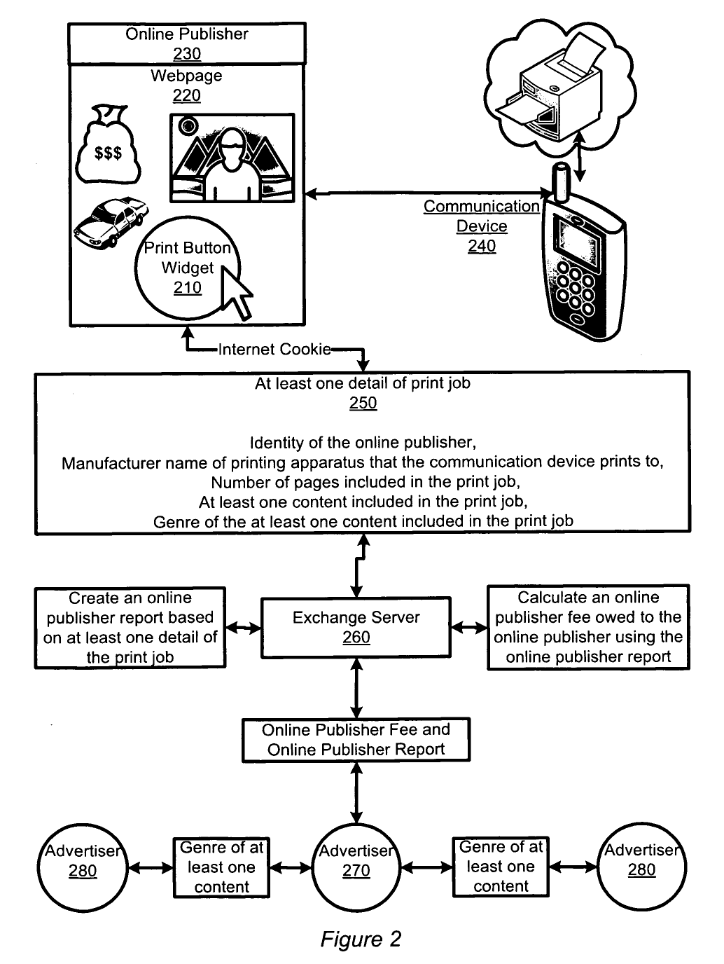

FIG. 2 illustrates a print button widget being accessed by a communication device and an exchange server acquiring at least one detail of a print job to create an online publisher fee and report for at least one advertiser according to an embodiment of the invention. As noted above, a communication device 240 may be a cell phone or a portable device that may access at least one content on a webpage 220. As illustrated in FIG. 2, a user may utilize the cell phone communication device 240 to access webpage 220.

As noted above, webpage 220 may be hosted and/or maintained by online publisher 230. When accessing webpage 220, cell phone communication device 240 may issue a request to download a print button widget 210 for display on webpage 220. Further, as noted above, the print button widget 210 may be a plug-in for webpage 220 and may be accessed through an exchange server 260. The exchange server may poll at least one Ad server and/or at least one advertiser for the print button widget 210. Additionally, the exchange server may also poll at least one Ad server and/or at least one advertiser for an ad to be displayed on webpage 220.

As illustrated in FIG. 2, after downloading the print button widget 210 and displaying the print button widget 210 on webpage 220, cell phone communication device 240 may access the print button widget 210 by scrolling over the print button widget 210 and pressing an input. When the print button widget 210 is accessed by cell phone communication device 240, the print button widget 210 may send an instruction back to cell phone communication device 240 to create a print job. As illustrated in FIG. 2, cell phone communication device 240 may not be physically coupled to a printing apparatus, however it may access one through a network. As noted above, the printing apparatus may be a kiosk that the cell phone communication device 240 may send a print job too. In one embodiment, the printing apparatus kiosk may be in a commercial retail store.

After sending the print instruction to cell phone communication device 240, the print button widget 210 may poll the cell phone communication device 240 for at least one detail of the print job 250 using a tracking tool. As illustrated in FIG. 2, the tracking tool may be an internet cookie associated with cell phone communication device 240 and webpage 220. The internet cookie may indicate the identity of the online publisher that hosts or maintains webpage 220. Additionally, the print button widget 210 may utilize the internet cookie to poll cell phone communication device 240 for a manufacturer name of the printing apparatus printed to. Further, the internet cookie may obtain the number of pages included in the print job, at least one content included in the print job, and the genre of the at least one content included in the print job from cell phone communication device 240. In one embodiment, the online publisher hosting webpage 220 may maintain a copy of the internet cookie and share the information from the internet cookie, include at least one detail of the print job 250, with an exchange server 260.

Additionally, as illustrated in FIG. 2, after at least one detail of the print job 250 has been acquired and sent to the exchange server 260, the exchange server 260 may proceed to create an online publisher report based on at least one detail of the print job 250. Additionally, the exchange server 260 may calculate an online publisher fee owed to the online publisher 230 using the online publisher report. Further, as illustrated in FIG. 2, the online publisher fee and the online publisher report may then be shared with at least one advertiser 270. In one embodiment, the online publisher report and the online publisher fee may be created and calculated upon request by at least one advertiser 270.

As illustrated in FIG. 2, at least one advertiser 270 may further share the online publisher report or at least one detail of the print job 250, included in the online publisher report, with at least one additional advertiser 280. Further, as illustrated in FIG. 2, at least one detail of the print job 250 may identify that at least one content printed was a picture of a car and the genre of at least one content printed was an automobile. At least one advertiser 270 may send this information to at least one additional advertiser 280 and collect a fee for this information.

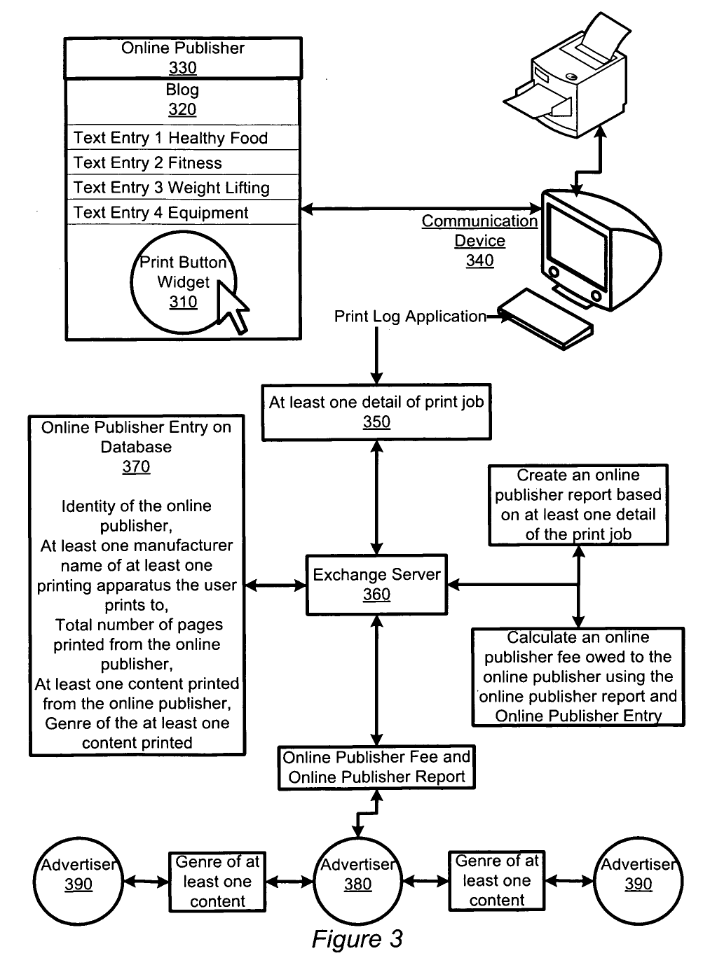

FIG. 3 illustrates an exchange server acquiring at least one detail of a print job to create or update a print usage entry for a corresponding online publisher on a database and the exchange server calculating an online publisher fee to share with an advertiser based on the print usage entry and an online publisher report according to an embodiment of the invention. As noted above, in one embodiment, an online publisher 330 may host the print button widget 310. Further, as noted above and illustrated in FIG. 3, the webpage may be a blog 320.

A user may initially access the blog 330 and the print button widget 310 on the blog 330 using a communication device 340. As noted above, the communication device 340 may be a desktop, laptop, and/or any other communication device that may access at least one content from a webpage or blog 330. Further, as noted above and illustrated in FIG. 3, the communication device 340 may be physically coupled to a printing apparatus. The user may use the communication device 340 to access the print button widget 310 on the blog 320 by “clicking” on the print button widget 310 using a mouse or another input device available to the communication device 340.

When the print button widget 310 has been accessed by the user, the print button widget 310 may issue an instruction to the communication device 340 to create a print job. Additionally, as illustrated in FIG. 3, the communication device may have a print log application installed. In the present embodiment, the print button widget 310 may poll the print log application by sending an instruction for the print log application to log at least one detail of the print job 350 and transfer at least one detail of the print job 350 to an exchange server 360. As illustrated in the present example, the print log application on the communication device 340 may communicate directly with the exchange server 360 to transfer at least one detail of the print job 350 to the exchange server 360.

Further, as illustrated in FIG. 3, the exchange server may utilize a database to store at least one detail of the print job 350 on a print usage entry for the corresponding online publisher 330. In the present embodiment, the print usage entry on the data base 370 may continually be updated with information from the print log application or using another tracking tool for the online publisher 330. After a predetermined period of time, which may be bi-weekly, monthly, or annually, or when a condition has been met, the exchange server 360 may create an online publisher report based on the print usage entry on the database 370 and calculate an online publisher fee owed to the online publisher 330 utilizing the online publisher report and the print usage entry on the database 370. As illustrated in FIG. 3 and noted above, in calculating the online publisher fee, the exchange server may determine an amount of ink utilized. The exchange server may identify at least one content printed may be only text on healthy foods, fitness, weight loss, and equipment. As a result, since only text was printed, less ink may have been utilized in the printing. In another embodiment, the exchange server may identify at least one content printed was a picture on the blog 320, as a result, more ink may have been used in the printing.

The exchange server 360 may then transfer the online publisher report and the online publisher fee to at least one advertiser 380. As noted above, at least one publisher may further issue an instruction back to the exchange server 360 for the exchange server to reset at least one detail recorded on the print usage entry on the database 370. At least one advertiser 380 may then submit a payment of the online publisher fee to the online publisher 330.

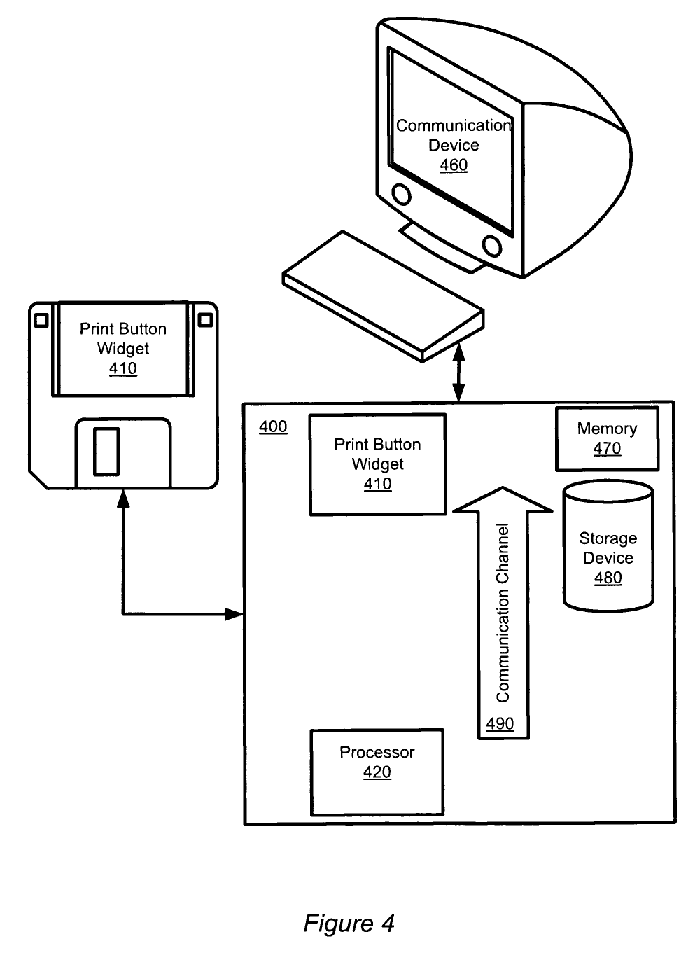

FIG. 4 illustrates a print button widget that may be stored onto a system and/or may be stored on a removable medium being accessed by a communication device according to an embodiment of the invention. As noted above and illustrated in FIG. 4, the print button widget may be requested by a communication device from a server, online host, exchange server, Ad server, and/or advertiser. Additionally, the print button widget may issue instructions to create a print job on the communication device when a user accesses the print button widget on a webpage.

Further, as noted above, the print button widget 410 may be plug-in or java script code that may be hosted on a webpage through an online publisher. Additionally, the print button widget 410 may be software which may be stored and accessed from a hard drive, a compact disc, a flash disk, a network drive or any other form of computer readable medium that is coupled to the system 400 or the online publisher. In one embodiment, the print button widget 410 may be stored on a server or another device that may or may not be connected to the system 400. The system 400 may utilize a local area network or a wide area network to store and access the print button widget 410. The print button widget 410 may be stored and accessed from additional devices in addition to and/or in lieu of those depicted in FIG. 4.

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one of ordinary skill within the relevant art and having possession of this disclosure, are to be considered within the scope of the invention.

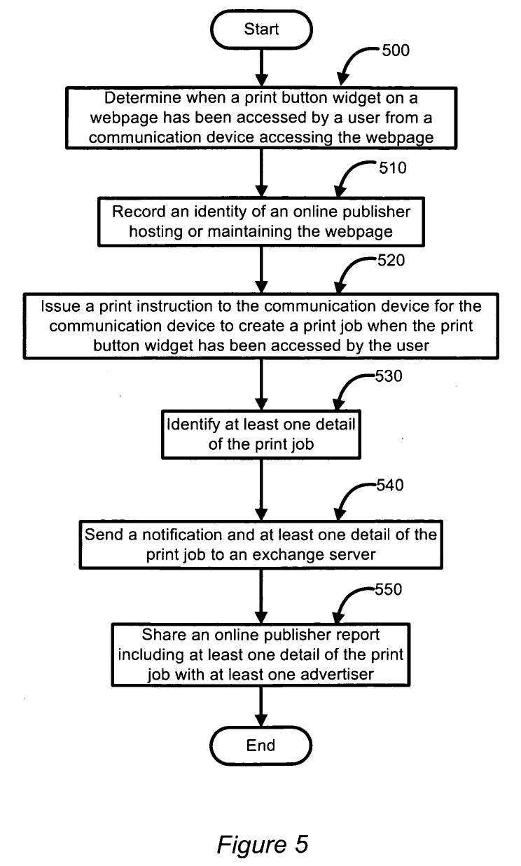

FIG. 5 is a flow chart illustrating a method for sharing an online publisher report of at least one detail of a print job with at least one advertiser when a print button widget on a webpage has been accessed according to an embodiment of the invention. The method of FIG. 5 may utilize a webpage from an online publisher, a print button widget from an advertiser, a communication device, a printing apparatus, an exchange server, and at least one advertiser. The method of FIG. 5 may utilize additional components and/or devices in addition and/or in lieu of those depicted in FIGS. 1 and noted above.

A print button widget on a webpage may initially determine when the print button widget has been accessed by a user from a communication device accessing the webpage 500. When the print button widget has been accessed, the identity of an online publisher hosting or maintaining the webpage may be recorded 510. After identifying an identity of an online publisher, a print instruction may be issued to the communication device for the communication device to create a print job when the print button widget has been accessed by the user 530. At least one detail of the print job may next be identified 540. After identifying at least one detail of the print job, a notification and at least one detail of the print job may be sent to an exchange server 550. An online publisher report including at least one detail of the print job may then be created and shared with at least one advertiser 560. The method may then be complete or the print button widget may continue to determine when the print button widget has been accessed by a user and repeat the method disclosed above.

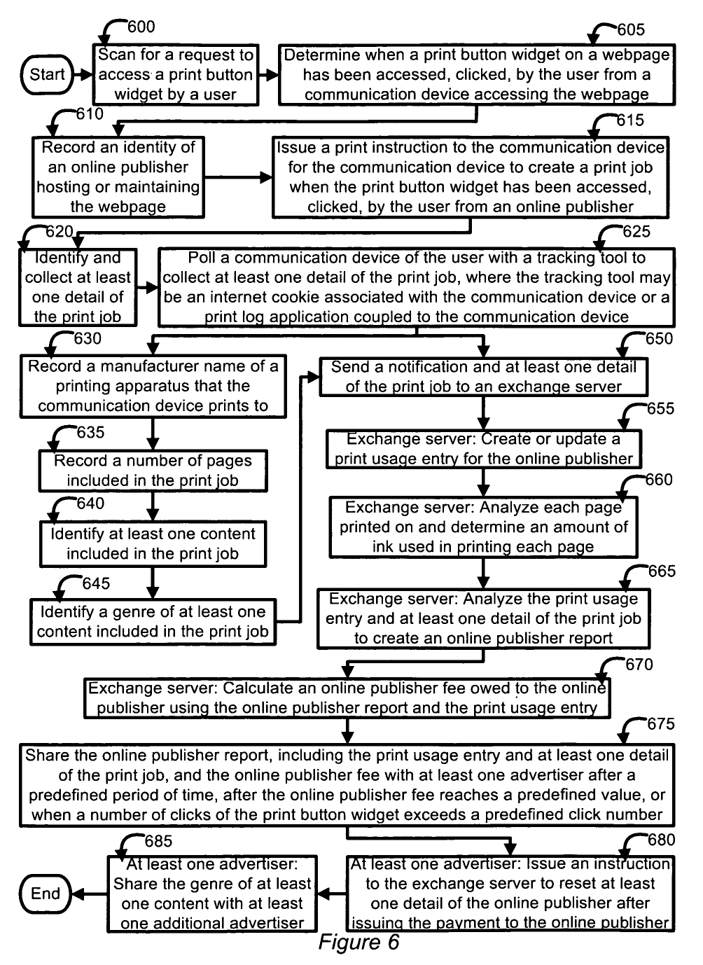

FIG. 6 is a flow chart illustrating a method for calculating an online publisher fee based on an online publisher report of at least one detail of a print job and sharing the online publisher fee and at least one detail of the print job with at least one advertiser according to an embodiment of the invention. The method of FIG. 6 may utilize a print button widget on a webpage hosted by an online publisher, a communication device, at least one printing apparatus, an exchange server, an Ad server, and at least one advertiser. The method of FIG. 6 may utilize additional components and/or devices in addition and/or in lieu of those depicted in FIGS. 1 and noted above.

The print button widget may initially scan for a request to access a print button widget by a user 600. In scanning for a request to access a print button widget, the print button widget may determine when a print button widget on a webpage has been accessed by a user from a communication device accessing the webpage 605. As noted above, a user may access the print button widget by clicking on the print button widget utilizing an input device, such as a mouse. Further, as noted above, the print button widget may be downloaded for the communication device through an exchange server polling an Ad server or at least one advertiser for the print button widget. If the print button widget has been accessed and/or clicked, then an identity of an online publisher hosting or maintaining the webpage may be recorded 610. The print button widget may then proceed to issue a print instruction to the communication device for the communication device to create a print job when the print button widget has been accessed and/or clicked by the user from an online publisher 615.

The print button widget may then identify and collect at least one detail of the print job 620. In identifying and collecting at least one detail, the print button widget may poll a communication device of the user with a tracking tool to collect at least one detail of the print job 625. As noted above, the tracking tool may be an internet cookie associated with the communication device or a print log application stored coupled to the communication device. Further, in identifying and collecting at least one detail of the print job, a manufacturer name of a printing apparatus that the communication device prints to may be recorded by the tracking tool 630. Additionally, a number of pages included in the print job may also be recorded by the tracking tool 635. Further, at least one content included in the print job may be identified and/or recorded by the tracking tool 640. As noted above, at least one content may include text, images, and/or any additional content available for view on the webpage. After identifying and/or recording at least one content, the tracking tool may identify a genre of at least one content included in the print job 645. Further, as noted above, the genre of the at least one content may indicate the subject matter of the text, images, and/or other additional content. A notification and at least one detail of the print job may then be sent to the exchange server 650.

In one embodiment, after the exchange server receives the notification and at least one detail of the print job, the exchange server may create or update a print usage entry for the online publisher 655. The exchange server may then proceed to analyze each page printed on and determine an amount of ink used in printing each page 660. Next, the exchange server may analyze the print usage entry and at least one detail of the print job to create an online publisher report 665. The exchange server may then calculate an online publisher fee owed to the online publisher using the online publisher report and the print usage entry 670.

After the online publisher fee has been determined, the exchange sever may share the online publisher report, including the print usage entry and at least one detail of the print job, and the online publisher fee with at least one advertiser 675. As noted above, the online publisher report and the online publisher fee may be shared after a predefined period of time, after the online publisher fee reaches a predefined value, or when a number of accesses/clicks of the print button widget exceed a predefined click number 675. In one embodiment, at least one advertiser may also proceed to issue an instruction to the exchange server to reset at least one detail of the online publisher in the print usage entry after issuing the payment to the online publisher 680. Further, at least one advertiser may then also proceed to share the genre of at least one content with at least one additional advertiser 685. As noted above, at least one advertiser may collect a payment for sharing the genre of at least one content with at least one additional advertiser.

The method may then be complete or the print button widget may continue to determine whether the print button widget has been accessed and proceed to create or update the online publisher report and the online publisher fee for at least one advertiser using the method disclosed above.

What is claimed is:

1. A method comprising:
determining when a print button widget on a webpage has been accessed by a user from a communication device accessing the webpage;
recording an identity of an online publisher hosting or maintaining the webpage;
issuing a print instruction to the communication device for the communication device to create a print job when the print button widget has been accessed by the user;
identifying at least one detail of the print job;
sending a notification and the at least one detail of the print job to an exchange server; and
sharing an online publisher report including the at least one detail of the print job with at least one advertiser.

2. The method of claim 1 further comprising:
recording a manufacturer name of a printing apparatus that the communication device prints to;
recording a number of pages included in the print job;
identifying at least one content included in the print job; and
identifying a genre of the at least one content included in the print job.

3. The method of claim 2 wherein the online publisher report may include at least one from the group consisting of: the identity of the online publisher, the manufacturer name of the printing apparatus that the communication device prints to, the number of pages included in the print job, the at least one content included in the print job, and the genre of the at least one content included in the print job.

4. The method of claim 1 wherein the exchange server may analyze the at least one detail of the print job to create or update the online publisher report.

5. The method of claim 4 wherein the exchange server may further calculate an online publisher fee owed to the online publisher using the online publisher report and send the online publisher fee to the at least one advertiser.

6. The method of claim 1 wherein the at least one advertiser may issue a payment to the online publisher after a predefined period of time or after the online publisher fee reaches a predefined value.

7. The method of claim 6 wherein the at least one advertiser may issue an instruction to the exchange server to reset at least one detail of the online publisher after issuing the payment to the online publisher.

8. A system comprising:
a processor connected to the system;
a print button widget connected to computer device readable memory on the system and configured to perform the steps of:
scan for request to access the print button widget by a user;
issue an instruction for a communication device to create a print job when the print button widget is accessed from an online publisher;
collect at least one detail of the print job;
send the at least one detail of the print job to an exchange server;
wherein the exchange server analyzes the print job and creates or updates a print usage entry for the online publisher;
further wherein the exchange server sends an online publisher report of the print usage entry to at least one advertiser after a predefined period of time or after the print job as been completed.

9. The system of claim 8, wherein the print usage entry includes at least one from the group consisting of: an identity of the online publisher, at least one manufacturer name of at least one printing apparatus a user prints to, a total number of pages printed from the online publisher, at least one content printed from the online publisher, and the genre of the at least one content printed from the online publisher.

10. The system of claim 8 wherein the print button widget may be stored on a server hosting a webpage or on an ad server accessed by the webpage or the user.

11. The system of claim 8 wherein the print button widget is further configured to poll the communication device of the user with a tracking tool to collect the at least one detail of the print job.

12. The system of claim 11 wherein the tracking tool may be an internet cookie associated with the communication device or a print log application coupled to the communication device.

13. The system of claim 12 wherein the print log application is configured to:
access the print job on the communication device;
record the at least one detail of the print job associated with the webpage;
send the at least one detail of the print job associated with the webpage to the exchange server;
send an update instruction to the exchange server to create or update the print usage entry for the corresponding online publisher.

14. The system of claim 9 wherein the exchange server or the at least one advertiser may create or update at least one ad shared with the online publisher based on the at least one content printed from the online publisher and the genre of the at least one content printed from the online publisher.

15. A computer-readable program in a computer-readable medium comprising:
a print button widget;
wherein the print button widget is configured to determine when the print button widget on a webpage has been clicked by a user from a communication device accessing the webpage;
wherein the print button widget is configured to issue a print instruction to the communication device to create a print job when the print button widget has been clicked by the user; and
further wherein the print button widget is configured to issue an instruction to send an online publisher report to an exchange server or at least one advertiser;
wherein the online publisher report includes at least one from the group consisting of an identity of the online publisher hosting the webpage, a manufacturer name of a printing apparatus used by the communication device, a number of pages included in the print job, at least one content included in the print job, and a genre of the at least one content.

16. The computer-readable program in a computer-readable medium of claim 15 wherein the print button widget may be served as a plug-in to a web browser on the communication device through an ad server coupled to the online publisher or the exchange network.

17. The computer-readable program in computer-readable medium of claim 15 wherein the print button widget is downloaded from an exchange server to the communication device, wherein the exchange server polls at least one ad server for the print button widget.

18. The computer-readable program in a computer-readable medium of claim 15 wherein the at least one advertiser may share the genre of the at least one content with at least one additional advertiser.

19. The computer-readable program in a computer-readable medium of claim 15 wherein the exchange server may analyze each page printed on the print job and determine an amount of ink used in printing each page based on the at least one content included in the print job.

20. The computer-readable program in a computer-readable medium of claim 15 wherein the print button widget may further be configured to issue an instruction to the at least one advertiser to issue a payment to the content provider after a number of clicks on the print button widget has exceed a predefined click number.
